(19) United States
(12) Patent Application Publication
(10) Pub. No.: US 2012/0007426 A1
(43) Pub. Date: Jan. 12, 2012

(54) Multiple DC power generation systems common load coupler

(76) Inventor: Steve A. Thompson, Irving, TX (US)

(21) Appl. No.: 12/803,841

(22) Filed: Jul. 8, 2010

(51) Int. Cl. H02J 1/10

(52) U.S. Cl. 307/43

(57) ABSTRACT

A simplified means to couple or network a plurality of DC Power Generating Systems having similar voltage ratings to a common bus or load.

### CROSS-REFERENCE TO RELATED APPLICATIONS

This application claims the benefit of provisional patent application Ser. No. 61/270,166, filed 2009 Jul. 6 by the present inventor, which is incorporated by reference.

### BACKGROUND

1. Prior Art

The following is a tabulation of some prior art that presently appears relevant:

### US Patents

| Patent No. | Kind Code | Issue Date | Patentee |
|---|---|---|---|
| 2085275 | A | June 1937 | Schmidt |
| 3631258 | A | December 1971 | Eisenstadt |
| 4156836 | A | May 1979 | Wiley |
| 4336485 | A | June 1982 | Stroud |
| 4347473 | A | August 1982 | Stroud |
| 4476395 | A | October 1984 | Cronin |
| 4539515 | A | September 1985 | Morishita et al |
| 4757249 | A | July 1988 | Farber et al |
| 4829228 | A | May 1989 | Beutemeister |
| 5254936 | A | October 1993 | Leaf et al |
| 5424599 | A | June 1995 | Stroud |
| 5600232 | A | February 1997 | Eavenson et al |
| 5739676 | A | April 1998 | Judge et al |
| 6044923 | A | April 2000 | Regan et al |

### Nonpatent Literature Document

James Hebert wrote in an article, “Dual Battery Wiring”, published via a web page (http://continuouswave.com/whaler/reference/dualBatter.html), a method of wiring two batteries using two alternators for a marine application.

2. Deficiencies of Prior Art

Previous patents and circuits have described the use of two or more generators (or alternators), or methods to slave a second generator/alternator for handling a common load, but none indicated a simple interconnection of two or more generators (or alternators) to handle a common load.

Schmidt, U.S. Pat. No. 2,085,275, covers dual DC Power Generating Systems wired separately from each other. In the case where such a multi power source DC system shares loads, various attempts to use switches, relays, or some such, have been used to prevent one DC Power Generating System from being connected at the same time to another DC Power Generating System while providing power for one or more loads (e.g., various marine applications published on/in web sites/pages). Regan et al in U.S. Pat. No. 6,044,923 shows means and method of a dual alternator with dual bus and independent batteries.

Another similar application has to do with emergency vehicles where the idea is to allow cross-over between the original wiring system and the “emergency equipment” system (Stroud U.S. Pat. Nos. 4,336,485 and 4,347,473). One of the deficiencies in the system is a demand for more than 150 amps but use of two alternators of no more than 130 Amps.

Building on Stroud's patents is Farber (U.S. Pat. No. 4,757,249) which provides a way to have two independent loads with a common load, arguing that this prevents a problem caused by a short circuit in one of the independent loads.

Another application (Wiley U.S. Pat. No. 4,156,836) demonstrated cross controlling the voltage regulators of a “Battery Charging System for Road Vehicles” in order to synchronize the power output and deal with various failure modes. Leaf et al (U.S. Pat. No. 5,254,936) demonstrates another dual alternator control means, with Stroud (U.S. Pat. No. 5,424,599) continuing in this vein. Eavenson et al (U.S. Pat. No. 5,600,232) deals with an asymmetrical DC Generating System with the two generators being interconnected. Judge et al (U.S. Pat. No. 5,739,676) shows a dual alternator with interconnected regulators to prevent fighting between the systems.

The need for two or more DC Power Generating Systems to supply power for some vehicle or apparatus has been recognized. But a simple approach to coupling these DC Power Generating Systems has not been discussed, or shown, and each of the various systems and attempts continue towards more complications (electrical, mechanical or some combination).

Before continuing, a definition of the phrase “DC Power Generation System(s)” as used in this patent filing is needed. Alternators (referred to as AC Generators by some) with both rectifier circuitry, and voltage regulation, to produce DC, and DC Generators, with voltage regulation, will be referred to interchangeably as DC Power Generating System(s).

One of the un-named issues (although “hinted at”) with these systems is seen in “jump starting” a vehicle using a second vehicle. When the first vehicle's engine starts and “revs up”, a sudden reverse current flow of greater than 40 amps may be seen accompanied with a voltage spike. This “surge” may be sufficient to ruin the voltage regulator of the first vehicle, with a “counter attack” of high DC voltage and current from the first vehicle ruining the voltage regulator of the second vehicle.

The means to couple DC power systems together for common load purposes is rather simple using solid state silicon based diodes available today. Further, this simplicity allows for automatic fail-over in a “symmetrical” implementation, and a degraded supply in an “asymmetrical” implementation.

An example of symmetrical implementation, as it applies to this invention: two DC Power Generating Systems having approximately the same voltage and current capacity, uses two alternators of the same model and “batch” from a manufacturer. Asymmetrical implementation, as demonstrated in various patents listed previously, may have one system with a max current output of 90 amps with a second system having a max current output of 130 amps.

The coupling of multiple DC Power Generation Systems together, even where the voltage regulation is imprecise does not pose a great problem as the battery (or batteries), in the system as a whole, behave as a very large capacitor. This capacitance effect controls the voltage seen by the various devices that are connected to the common bus such that any ripple in the voltage is kept within the design range of devices being used (e.g., but not limited to, two-way radios, GPS units, electric motors).

### BRIEF DESCRIPTION OF DRAWINGS

The drawings show simple systems that plug together to make a complex system where the electrical load is attached to a common bus.

FIG. 1 Shows a DC Power Generating System made with an alternator or generator (10) connected to a battery (12) where one side is connected to ground (14) and the other side to the external power connector (16).

FIG. 2 Shows a DC Power Generating System made with an alternator or generator (20) where one side is connected to ground (24) and the other side to the external power connector (22).

FIG. 3 Shows parallel power circuits driving a common load through a common bus (40).

FIG. 4 Shows parallel power circuits driving a common load through a common bus (46) with a common battery.

### DRAWINGS

### Reference Numerals

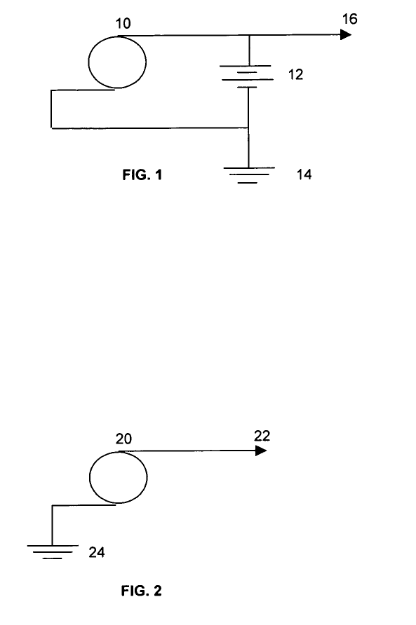

10 Alternator or Generator with voltage regulation
12 Battery (symbol used only to show battery, not polarity)
14 Common ground connection (positive or negative)
16 External power connector
20 Alternator or Generator with voltage regulation
22 External power connector
24 Common ground connection (positive or negative)
30 Diode for current direction control
32 Diode for current direction control
34 Common load
36 Common ground connection (positive or negative)
38 Optional nth Diode for current direction control
40 Common bus
42 Power connection from a DC Power Generating System (as shown in FIG. 1)
44 Power connection from a DC Power Generating System (as shown in FIG. 1)
46 Optional nth Power connection from a DC Power Generating System (as shown in FIG. 1 or 2)
48 Common bus
50 Battery for Common Battery system (symbol used only to show battery, not polarity)
52 Common ground connection (positive or negative)
54 Common load
56 Common ground connection (positive or negative)
60 Power connection from a DC Power Generating System (as shown in FIG. 1 or 2)
62 Power connection from a DC Power Generating System (as shown in FIG. 1 or 2)
64 Optional nth Power connection from a DC Power Generating System (as shown in FIG. 1 or 2)
66 Diode for current direction control
68 Diode for current direction control
70 Optional nth Diode for current direction control

### BACKGROUND AND SUMMARY OF THE INVENTION

The invention allows a plurality of DC Power Generating Systems to be used to provide power to a common bus or load, the proviso being that all said DC Power Generating Systems being interconnected (coupled) be of the same “voltage band.”

“Voltage bands” are defined via the battery voltage used in/for the vehicle's electrical system. Specifically, looking at vehicular systems (e.g., but not limited to, General Aviation, marine, trucks, and automobiles), the voltage range used is based on the fully charged state of the battery used by said vehicles through the design limits. Examples, 6-8 VDC systems (basically pre-1960 automobiles), 12-14 VDC systems, 24-28 VDC systems, 48-52 VDC, etc.

This invention addresses problems and needs within different types of vehicles for a plurality of DC Power Generating Systems. In the area of General Aviation (typically aircraft under 12,000 pounds max take-off weight), electrical redundancy is a safety issue (besides being a regulatory issue). As more General Aviation single engine aircraft move to “glass cockpits” or to the ADS-B (Next Gen) environments, there is a need for having a plurality of DC Power Generating Systems.

In the area of motor vehicles and marine vehicles having a plurality of DC Power Generating Systems sharing the electrical load, or providing for a common bus, redundancy is provided when, or where, one of the power generation systems fails, the vehicle can still have all the required safety devices still working while giving the operator(s) time to shut off all unnecessary devices (loads).

There is a second basic design where a single system battery is used while having a plurality of DC Power Generating Systems connected using said battery. However, said design leaves said battery as a single point of failure.

### SUMMARY OF THE INVENTION

The invention addresses inter-system coupling problems by using current limiting device(s) to limit or prevent current flow in such a way that any or all DC Power Generating Systems has a singular path to and through the desired common bus or common load. This invention also makes use of existing DC Power Generating Systems having voltage regulation where said power generating system is not coupled to adjacent DC Power Generating Systems. The result is, said DC Power Generating System senses the demand presented to it such that said system's output is properly controlled by said system's voltage regulator.

The DC Power Generation Systems Common Load Coupler (Coupler) allows multiple DC Power Generation Systems to be coupled to a common bus, or load, preventing parallel current path issues caused where one DC Power Generating System has a current path through an adjacent DC Power Generating System (Kirchoff's law(s) demonstrate such unintended parallel pathing). The Coupler prevents alternate current paths by preventing reverse current flow.

Another benefit of said Coupler circuitry has to do with DC Power Generating Systems today typically having self-contained voltage regulator/rectifier circuits that use zener diodes and/or other solid state devices which may be sensitive to a sudden reverse current flow, which may be accompanied by a voltage spike. Said sensitivity may result in regulator circuit failure. The Coupler circuit prevents this failure mode.

The Coupler does not depend on the apparatus used to drive the generator or how the generator is made of a DC Power Generation system. However, the current limiting devices may need to be attached to a heat sink (or each to a separate heat sink), depending on which type and size of current limiting device(s) used, and the actual application (e.g., aircraft, boat, Semi tractor, ambulance, etc.), or current draw.

### DETAILED DESCRIPTION

### Embodiments

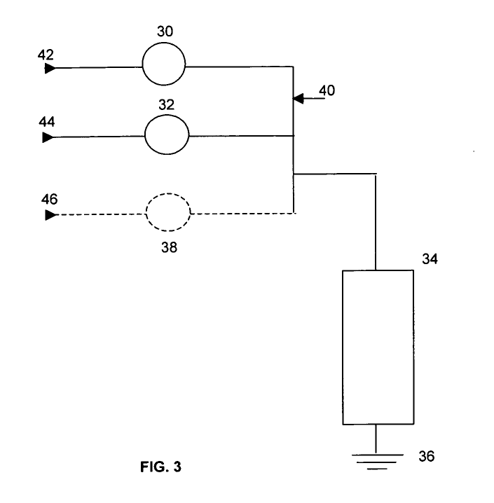

One embodiment of the Multiple DC Power Generation Systems Common Load Coupler is illustrated by connecting two of the DC Power Generating Systems shown in FIG. 1 to the power plugs of FIG. 3 which then couples the DC Power Generation Systems (of FIG. 1) with the common load 34 via the common bus 40.

The above embodiment would be accomplished by attaching a first DC Power Generation System's (as shown in FIG. 1) external power connector 16 to said common bus (40) (FIG. 3) power connection 42, and a second DC Power Generation System's (as shown in FIG. 1) external power connector 16 to said common bus (40) (FIG. 3) via power connection 44. The diodes (30, 32) would prevent said DC Power Generation Systems from being coupled to each other while at the same time being coupled to said common load 34.

According to another preferred embodiment which is a variation of the immediately preceeding embodiment, where another DC Power Generation System (as shown in FIG. 1) would be attached using said system's external power connector 16 to said common bus (40) power connection 46. This other said DC Power Generation System would be prevented from being coupled to other said DC Power Generation Systems by diodes (38, 32, 30) while being coupled to said common load 34 via said common bus 40. There could be several such “optional” DC Power Generation Systems coupled in like fashion. This embodiment allows for redundancy in such a way that current supply would be greater than the load would demand such that one said DC Power Generation Systems could fail and the load would still be supplied the needed current at the proper voltage.

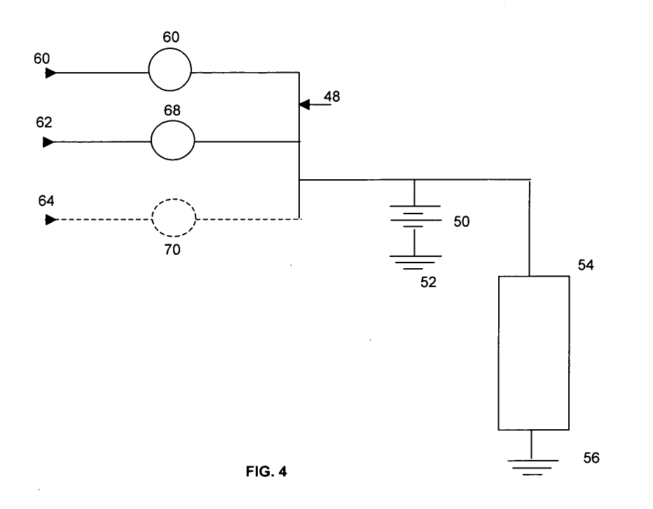

According to another preferred embodiment, multiple DC Power Generation Systems are connected by connecting two of the systems shown as FIG. 2 to the power plugs of FIG. 4 which then couples the DC Power Generation Systems (of FIG. 2) to the common load 54 via the common bus 48.

The above embodiment would be accomplished by attaching a first DC Power Generation System's (as shown in FIG. 2) external power connector 22 to said common bus (FIG. 4) power connection 60, and a second DC Power Generation System's (as shown in FIG. 2) external power connector 22 to said common load 54 (FIG. 4) via said common bus 48 from power connection 62. The diodes (60, 68) would prevent said DC Power Generation Systems from being coupled to each other while at the same time being coupled to said common load, and being able to maintain the charge of the common battery 50.

According to another preferred embodiment is a variation of the immediately preceeding embodiment, where another DC Power Generation System (as shown in FIG. 2) would be attached using said system's external power connector 22 to said common load's (54) power connection 64. This other said DC Power Generation System would be prevented from being coupled to other said DC Power Generation Systems by diodes (70, 60, 68) while being coupled to said common load 54 via said common bus 48. There could be several such “optional” DC Power Generation Systems coupled in like fashion. This embodiment also allows for a current supply to be greater than the load would demand such that one of the said DC Power Generation Systems could fail and the load would still be supplied the needed current at the proper voltage, while maintaining the charge of the common battery 50.

According to another preferred embodiment, one may mix DC Power Generation Systems of FIG. 1 and FIG. 2 to supply said common load 54 via said common bus 48. There is nothing to preclude the using of DC Power Generation Systems as described in FIG. 1 from being used to supply said common load 54 as defined in FIG. 4.

I claim:

1. An electrical system allowing two or more DC Power Generating Systems to be interconnected together to supply power to a common bus, said electrical system comprising:
one or more current limiting devices between the power connection from each said DC Power Generating System to said common bus.
